(19) United States
(12) Patent Application Publication
(10) Pub. No.: US 2010/0032859 A1
(43) Pub. Date: Feb. 11, 2010

(54) INJECTION MOLDING SUBSTANCE AND MANUFACTURING METHOD THEREOF

(75) Inventors: Byung Hoon Ryou, Seoul (KR); Young Sam Kwon, Gyeonggi-do (KR)

Correspondence Address: MILLER NASH LLP, 601 UNION STREET, SUITE4400, SEATTLE, WA, 98101-2352, US

(73) Assignee: HPM TECHNOLOGY CO., LTD., Seoul (KR)

(21) Appl. No.: 11/720,831

(22) PCT Filed: Feb. 23, 2007
(86) PCT No.: PCT/KR07/00942

§ 371 Date: Jun. 4, 2007

(30) Foreign Application Priority Data
Feb. 24, 2006 (KR) 10-2006-0018258

(51) Int. Cl. B28B 1/48; B29C 33/00

(52) U.S. Cl. 264/154; 264/219

(57) ABSTRACT

A method of manufacturing an injection molding substance and the injection molding substance is provided. The method of manufacturing an injection molding substance including: providing a molding compound including a powder; making an intermediate mold by injection molding using the molding compound; cutting a portion of the intermediate mold; and sintering the cut intermediate mold.

### TECHNICAL FIELD

The present invention relates to an injection molding substance and a manufacturing method thereof, and more particularly, to an injection molding substance and a manufacturing method thereof which may be easily manufactured, improve a machining precision and a productivity, and reduce a manufacturing cost.

### BACKGROUND ART

Generally, nozzles are fine pipes or tubes located at the end of fluid flow path to enable fluid or gas to be ejected at a high speed. When high-pressure fluid is ejected and an amount of fluid or gas which is ejected at a time decreases, pressure energy is converted to kinetic energy, which is used in nozzles. As an example, injection nozzles for diesel engines are included in nozzles. Injection nozzles for diesel engines are installed to enable high-pressure fuel to be sprayed into combustion chambers of diesel engines.

Such injection nozzles for diesel engines include nozzle bodies, needle valves, nozzle springs, push rods, and the like. When high-pressure fuel provided from an injection pump is transferred to a pressure chamber, formed in a nozzle body, via a delivery pipe and an fuel injection passage, high-pressure is applied to a needle valve. The needle valve compresses a nozzle spring, and is operated upwards. Accordingly, fuel is sprayed into a combustion chamber via a nozzle which is selectively open according to such operation of the needle valve.

Also, such injection nozzles for diesel engines, which are used under a harsh environment as described above, are generally formed by using wear resistant high-strength base metal to satisfy required physical properties.

A method of manufacturing an injection nozzle for a diesel engine in a conventional art is described. FIG. 1 is a diagram illustrating a method of manufacturing an injection nozzle for a diesel engine in a conventional art.

As illustrated in FIG. 1, a nozzle body of the injection nozzle for a diesel engine in the conventional art is manufactured by the following operations: providing a wear resistant high-strength base metal 10, cutting an inside and outside of the wear resistant high-strength base metal 10 and machining the wear resistant high-strength base metal 10 in a nozzle shape, and forming a spray opening 11 on a front part of the wear resistant high-strength base metal 10.

However, since the nozzle body is made of the wear resistant high-strength base metal 10, a cutting process may not be easily performed. Accordingly, in the conventional art, the spray opening 11 should be formed by a separate special machining such as an electric discharge machining (EDM) or a laser machining.

In FIG. 1, a reference numeral 20 designates cutting tool for performing the cutting process, and a reference numeral 30 designates machining tool for performing an electric discharge machining.

Since the spray opening 11 is formed by the EDM or the laser machining in the conventional art, a manufacturing cost increases and a machining speed decreases. Accordingly, the method of manufacturing an injection nozzle for a diesel engine in the conventional art is not suitable for mass production.

Also, a spray feature of the spray opening 11 may vary depending on a diameter of the spray opening 11 and a machining precision. Accordingly, a small diameter and a high machining precision are required to enable a fuel to be optimally sprayed within a cylinder. However, in the case of the EDM or the laser machining, a minimization of the spray opening 11 is limited to a fine size. Also, when the spray opening 11 is processed in a smaller size than the fine size by the EDM or the laser machining, the machining precision may decrease.

### DISCLOSURE OF INVENTION

### Technical Goals

The present invention provides an injection molding substance and a manufacturing method thereof which may be manufactured more easily and reduce a manufacturing cost.

The present invention also provides an injection molding substance and a manufacturing method thereof which is manufactured easily and rapidly, and thereby may be suitable for mass production and improve a machining precision.

The present invention also provides an injection nozzle for a diesel engine with a high machining precision.

### Technical Solutions

According to an aspect of the present invention, there is provided a method of manufacturing an injection molding substance, the method including: providing a molding compound including a powder; making an intermediate mold by injection molding using the molding compound; cutting a portion of the intermediate mold; and sintering the cut intermediate mold.

A metal powder may be used as the powder, and a nonmetal powder and the metal powder may be mixed and used together. Also, a functional additive may be mixed to improve various physical properties. A molding compound may be comprised a binder. A plurality of binders having a melting point different from each other may be provided. As an example, the plurality of binders includes a wax and a plastic. Also, a bonding agent, a lubricant, a plasticizer, a surfactant, and a mixture of the above-described materials may be added to the binder.

The intermediate mold may be formed in various shapes depending on a need. Accordingly, when cutting the portion of the intermediate mold, a hole machining and an internal/external machining may be performed.

Also, degreasing the cut intermediate mold may be further performed to enable at least a portion of the binder to be removed before sintering the intermediate mold.

When the plurality of binders having a physical property, e.g. a melting point, which is different from each other, is provided, the degreasing may be divided into a plurality of degreasing processes. As an example, the degreasing includes a first degreasing process and a second degreasing process. A binder having a relatively low melting point is removed in the first degreasing process, and a binder having a relatively high melting point is removed in the second greasing process. In the first degreasing process, a wax having a relatively low melting point may be removed. In the second degreasing process, a plastic having a relatively high melting point may be removed.

Also, the first degreasing process may be preferably performed before cutting the portion of the intermediate mold, since the wax has the relatively low melting point. Specifically, when cutting the portion of the intermediate mold, the wax is melted by heat generated in the cut portion, and a chip is prevented from being separated. Also, the melted wax may be adhered to the cut portion. That is, when cutting the portion of the intermediate mold including the wax, the wax is melted by heat generated by the cutting, and a chip exhaustion load and cutting rotation load increase. Accordingly, the first degreasing process may be preferably performed before cutting the portion of the intermediate mold.

Also, the second degreasing process may be performed after cutting the portion of the intermediate mold, or may be successively performed after the first degreasing process described above.

The injection molding substance according to the present invention may be widely used as a mechanical component used in a car, consumer electronics, a precision instrument, and the like.

### BRIEF DESCRIPTION OF DRAWINGS

FIG. 1 is a diagram illustrating a method of manufacturing an injection nozzle for a diesel engine in a conventional art;

FIG. 2 is a flowchart illustrating a method of manufacturing an injection molding substance according to the present invention;

FIGS. 3, 4, 5, and 6 are diagrams illustrating a method of manufacturing an injection molding substance according to the present invention;

FIG. 3 is a cross-sectional view illustrating a process of making an intermediate mold by an injection molding;

FIG. 4 is a cross-sectional view illustrating a process of degreasing an intermediate mold in a degreasing furnace;

FIG. 5 is a cross-sectional view illustrating a process of forming a spray opening in an intermediate mold;

FIG. 6 is a cross-sectional view illustrating a process of sintering an intermediate mold in a sintering furnace;

FIG. 7 is a cross-sectional view illustrating a change of a diameter of a spray opening after sintering; and

FIG. 8 is a cross-sectional view illustrating a configuration of an injection molding substance according to an embodiment of the present invention.

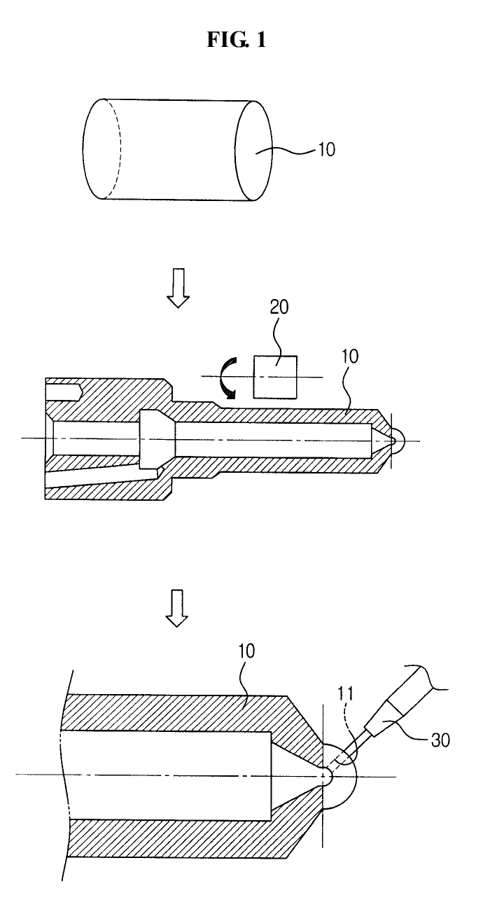

### Best MODE FOR CARRYING OUT THE INVENTION

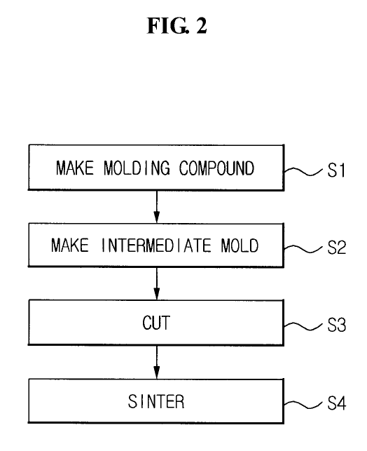

FIG. 2 is a flowchart illustrating a method of manufacturing an injection molding substance according to an embodiment of the present invention.

As illustrated in FIG. 2, the method of manufacturing an injection molding substance includes providing a molding compound including a powder and a binder in operation S1, making an intermediate mold by an injection molding using the molding compound in operation S2, cutting a portion of the intermediate mold in operation S3, and sintering the cut intermediate mold in operation S4.

In operation S1, the molding compound including the powder and the binder is provided. The powder and the binder have specific gravities different from each other. The molding compound may be provided by combining the powder and the binder in a predetermined mixture ratio at a predetermined temperature. Also, the molding compound may be formed as a feedstock of a predetermined size to enable the molding compound to be easily provided to an injection molding machine.

As the powder, a metal powder or a mixture of various metal powders may be used. The metal powder may include a wear resistant steel such as SKD and SCM or a stainless steel such as a 440C, 420, 630, and the like. Also, a nonmetal powder or a mixture of various nonmetal powders may be used with the metal powder. The nonmetal powder may include a WC-Co powder, a ceramic powder such as zirconia, alumina, and the like. A functional additive may be added to improve various physical properties.

The binder is added to improve fluidity of molding compound in injection molding and keep the powder solid after being molded. The binder may include a plurality of binders having melting points different from each other. As an example, the plurality of binders may include a wax and a plastic. Polyethylene or a polypropylene may be used as the binder made of the plastic. A melting point of the polyethylene and the polypropylene is approximately 150˜180° C. A wax having a melting point of approximately 50˜70° C. may be used as the wax. Also, a bonding agent, a lubricant, a plasticizer, a surfactant, and a mixture of the above-described materials may be added to the binder.

In operation S2, the intermediate mold having a predetermined shape is formed by using the molding compound. The intermediate mold may be made by a metal injection molding (MIM) method. The MIM method has advantages of both injection molding technology and sintering technology of metal powder. The injection molding technology is used in a plastic industry and the sintering technology is developed in a powder metallurgy industry.

Specifically, the molding compound is transferred into a cylinder of the injection molding machine, is plasticized and is transferred. Also, the molding compound is pressurized into a mold from a nozzle of the cylinder, is cooled and is solidified. Accordingly, the intermediate mold may be formed.

In operation S3, a portion of the intermediate mold is cut according to a request.

In this instance, the cutting may be divided into a cutting by a tool and a cutting by a particle. The cutting by the tool includes a turning, a planing, a milling, a drilling, a boring, and the like. The cutting by the particle includes a grinding, a honing, a lapping, and the like.

In operation S4, sintering the intermediate mold is performed in a high-temperature sintering furnace to enable a pore of the intermediate mold to be removed. Accordingly, manufacturing of the injection molding substance is complete.

Also, a process of degreasing the intermediate mold may be added before sintering the intermediate mold. When degreasing the intermediate mold, at least a portion of the binder may be removed.

Specifically, since the binder for the injection molding is not necessary when sintering, the binder may be evaporated/resolved by the degreasing using a general degreasing furnace before sintering the intermediate mold. However, a portion of binder may remain to maintain a shape of the intermediate mold. The remaining amount of the binder may vary depending on a condition of the degreasing.

In this instance, when the plurality of binders having physical properties different from each other, e.g. a melting point, is provided, the degreasing may be divided into a plurality of degreasing processes. As an example, when the plurality of binders includes a wax and a plastic, the degreasing may include a first degreasing process and a second degreasing process. A binder having a relatively low melting point is removed in the first degreasing process, and a binder having a relatively high melting point is removed in the second greasing process. In the first degreasing process, a wax having a relatively low melting point may be removed. In the second degreasing process, a plastic having a relatively high melting point may be removed.

Also, the first degreasing process for removing the wax may be embodied by a solvent degreasing method using a solvent such as N-hexane, heptane, a thinner, and the like. The second degreasing process may be embodied by a pyrolysis degreasing method. Also, a general degreasing method such as an electrolytic degreasing method and an ultrasonic degreasing method may be applied instead of a degreasing method described above to be applicable to the first degreasing process and the second degreasing process.

Also, the first degreasing process, which removes the binder having the relatively low melting point, may be preferably performed before cutting the portion of the intermediate mold, since the wax has the relatively low melting point. Specifically, when cutting the portion of the intermediate mold, the wax is melted by heat generated in the cut portion, and a chip is prevented from being separated. Also, the melted wax may be adhered to the cut portion. That is, when cutting the portion of the intermediate mold including the wax, the wax is melted by heat generated by the cutting, and a chip exhaustion load and cutting rotation load increase. Accordingly, the first degreasing process may be preferably performed before cutting the portion of the intermediate mold.

Also, the second degreasing process, which removes the binder(for example, plastic) having the relatively high melting point, may be performed after cutting the portion of the intermediate mold, or may be successively performed after the first degreasing process described above.

A density gradient of the intermediate mold may be controlled by controlling a granularity of the powder or changing a material of the binder.

As described above, the injection molding substance according to the present invention may be manufactured by a metal injection molding (MIM), and the cutting is performed according to the request before sintering the intermediate mold. Accordingly, the injection molding substance may be easily manufactured, and a manufacturing cost may decrease.

Specifically, according to the present invention, the cutting, e.g. a hole machining, is performed according to the request in the intermediate mold which is relatively weaker than a wear resistant base metal. Thus, the injection molding substance may be easily manufactured, and the manufacturing cost may decrease compared to directly cutting the wear resistant base metal.

Also, according to the present invention, since the intermediate mold may be formed in various shapes according to the request when making the intermediate mold, a separate internal/external machining to form the wear resistant base metal in a requested shape may be omitted. Also, wasted process scrap may decrease.

Hereinafter, as an example of the injection molding substance, an injection nozzles for a diesel engine, which is manufactured by the method of manufacturing an injection molding substance according to the present invention, is described.

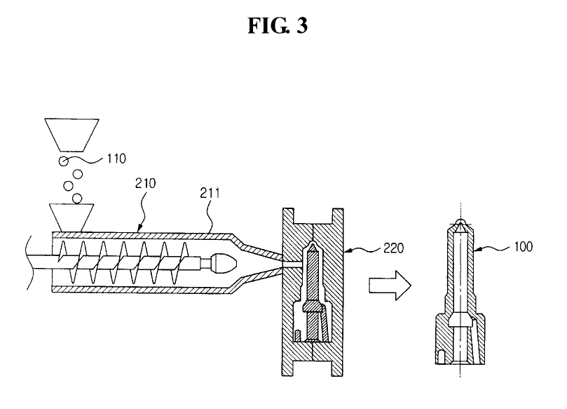

FIGS. 3, 4, 5, and 6 are diagrams illustrating a method of manufacturing an injection molding substance according to the present invention.

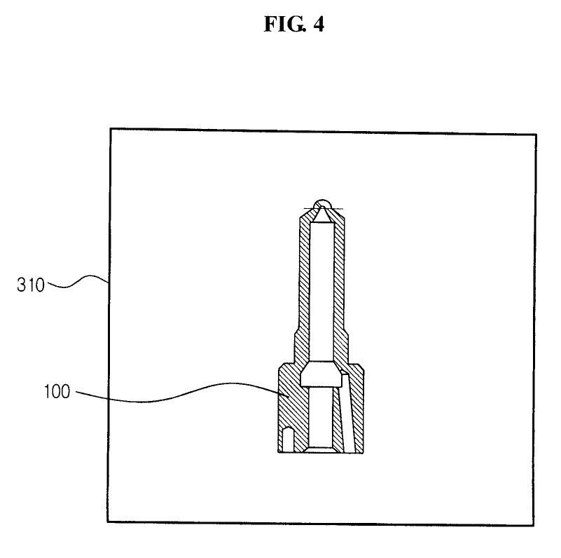

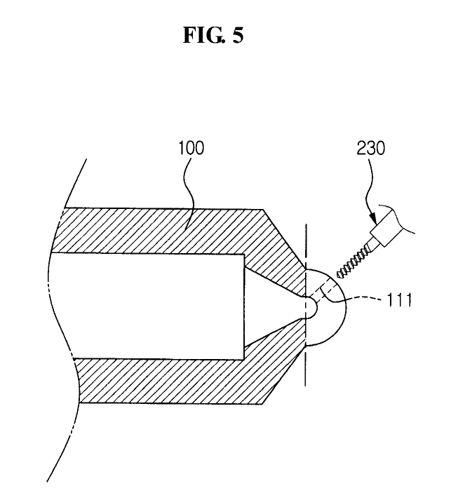

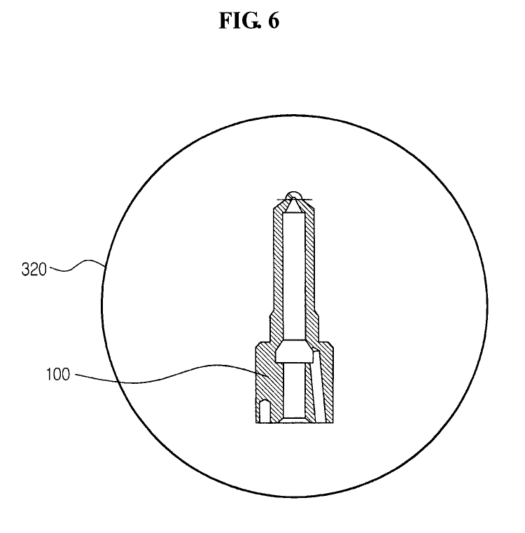

FIG. 3 is a cross-sectional view illustrating a process of making an intermediate mold by an injection molding. FIG. 4 is a cross-sectional view illustrating a process of degreasing an intermediate mold in a degreasing furnace. FIG. 5 is a cross-sectional view illustrating a process of forming a spray opening in an intermediate mold. FIG. 6 is a cross-sectional view illustrating a process of sintering an intermediate mold in a sintering furnace.

As illustrated, a method of manufacturing an injection molding substance includes providing a molding compound 110 including a powder and a binder, making an intermediate mold 100 by an injection molding using the molding compound 110, cutting a portion of the intermediate mold 100, and sintering the cut intermediate mold 100.

The molding compound 110 including the powder and the binder is provided. The powder and the binder have specific gravities different from each other. The molding compound 110 may be provided by combining the powder and the binder in a predetermined mixture ratio at a predetermined temperature. Also, the molding compound 110 may be formed as a feedstock of a predetermined size to enable the molding compound 110 to be easily provided to an injection molding machine.

As the powder, a metal powder or a mixture of various metal powders may be used. The metal powder includes a wear resistant steel such as SKD and SCM or a stainless steel such as 440C, 420, 630, and the like. Also, a nonmetal powder or a mixture of various nonmetal powders may be used with the metal powder. The nonmetal powder includes WC-Co powder, a ceramic powder such as zirconia, alumina, and the like. A functional additive may be added to improve various physical properties.

The binder is added to improve fluidity of molding compound in injection molding and keep the powder solid after being molded. A plurality of binders having a melting point different from each other may be provided. As an example, the plurality of binders may include a wax and a plastic. Polyethylene or a polypropylene may be used as the binder made of the plastic. A melting point of the polyethylene and the polypropylene is approximately 150˜180° C. A wax having a melting point of approximately 50˜70° C. may be used as the wax. Also, a bonding agent, a lubricant, a plasticizer, a surfactant, and a mixture of the above-described materials may be added to the binder.

A volume ratio of the powder in the molding compound 110 may be 35%˜65%. A volume ratio of the binder in the molding compound 110 may also be 35%˜65%. The volume ratios of the powder and the binder may vary according to a request and a design specification. The present invention may not be limited by the volume ratios of the powder and the binder.

The intermediate mold 100 in a nozzle shape is formed through a MIM by using the molding compound 110. With respect to the nozzle shape, one end is open and another end is closed. A diameter of the intermediate mold 100 in the closed end is smaller than a diameter of the intermediate mold 100 in the open end.

Specifically, the molding compound 110 is transferred into a cylinder 211 of the injection molding machine 210, is plasticized and is transferred. Also, the molding compound 110 is pressurized in a mold 220 from a nozzle of the cylinder, is cooled and is solidified. Accordingly, the intermediate mold 100 may be extracted.

Also, a density gradient of the intermediate mold 100 may be controlled by controlling a granularity of the powder or changing a material of the binder. The molding compound 100 may be formed to have a porosity of at least 10%, and preferably from 10% to 90%.

The degreasing may be performed by using a degreasing furnace 310 to enable at least a portion of the binder included in the intermediate mold 100 of the nozzle shape to be removed.

In this instance, when the plurality of binders having the physical property, e.g. the melting point, which is different from each other, is provided, the degreasing may be divided into a plurality of degreasing processes. As an example, when the plurality of binders includes a wax and a plastic, the degreasing includes a first degreasing process and a second degreasing process. A binder having a relatively low melting point is removed in the first degreasing process, and a binder having a relatively high melting point is removed in the second greasing process. In the first degreasing process, a wax having a relatively low melting point may be removed. In the second degreasing process, a plastic having a relatively high melting point may be removed.

Also, the first degreasing process may be embodied by a solvent degreasing method using a solvent such as N-hexane, heptane, a thinner, and the like. The second degreasing process may be embodied by a pyrolysis degreasing method. Also, a general degreasing method such as an electrolytic degreasing method and an ultrasonic degreasing method may be applied instead of a degreasing method described above to be applicable to the first degreasing process and the second degreasing process.

Also, the first degreasing process, which removes the binder having the relatively low melting point, may be preferably performed before cutting the portion of the intermediate mold 100, since the wax has the relatively low melting point. Specifically, when cutting the portion of the intermediate mold 100, the wax is melted by heat generated in the cut portion, and a chip is prevented from being separated. Also, the melted wax may be adhered to the cut portion. That is, when cutting the portion of the intermediate mold 100 including the wax, the wax is melted by heat generated by the cutting, and a chip exhaustion load and cutting rotation load increase. Accordingly, the first degreasing process may be preferably performed before cutting the portion of the intermediate mold 100.

Also, the second degreasing process, which removes the binder having the relatively high melting point, may be performed after cutting the portion of the intermediate mold 100, or may be successively performed after the first degreasing process followed by the cutting being performed after the second degreasing process.

A spray opening 111 is formed in the closed end of the intermediate mold 100. The spray opening 111 may be formed by drilling or a laser machining using a tool. Also, a plurality of spray openings 111 may be formed around a circumference of the intermediate mold 100 depending on a need. The plurality of spray openings 111 may be formed simultaneously or sequentially by a drill machine 230.

Hereinafter, an example of the spray opening 111, formed by a micro drill, is illustrated. The spray opening 111 may be formed by a variety of machining methods for forming a hole, e.g. an EDM. In the present embodiment of the present invention, an example of the spray opening 111 which is formed by the micro drill in the intermediate mold 100 is described, however the cutting according to the present invention may include forming of the spray opening 111 by using the micro drill and forming of various patterns having a similar or same size of the spray opening 111 by using a tool similar to the micro drill.

As described above, since the cutting is performed before sintering the intermediate mold 100 and the wax having the relatively low melting point may be removed before cutting the portion of the intermediate mold 100, the spray opening 111 having a micromini diameter and a deep depth may be formed by the micro drill in the intermediate mold 100. The spray opening 111 may preferably have a large proportion of a depth to a diameter. As an example, A proportion of a depth to a diameter of the spray opening is from 1 to 100.

A diameter of the micro drill may be any one of 0.05 mm, 0.1 mm, 0.15 mm, 0.2 mm, 0.25 mm, and 0.3 mm. Also, micro drills having various diameters may be used according to the request.

As an example, the proportion of the depth to the diameter of the spray opening 111 may be 20, e.g. 1 mm/0.05 mm or 2 mm/0.1 mm. Also, the proportion of the depth to the diameter of the spray opening 111 may be manufactured to be larger by using a micro drill having a longer flute.

The micro drill may preferably rotate at least 10,000 revolutions per minute (RPM), and more preferably at least 20,000 RPM, to form the spray opening 111 having the micromini diameter and the deep depth described above at a high speed. As the RPM of the micro drill increases, the machining speed may increase, since a machining speed of a drill is generally proportional to a diameter and an RPM of the drill. Accordingly, a high RPM of the micro drill may be preferable within a range where one can control the micro drill, which may be dependent on a general control method.

Also, the spray opening 111 may be preferably formed by repeatedly reciprocating the micro drill. Specifically, when the proportion of the depth to the diameter of the spray opening 111 is large, in order to enable a chip to be easily separated, the micro drill is transferred to a predetermined depth of the intermediate mold 100, is pulled out from the intermediate mold 100, and is transferred into the intermediate mold 100 again, to cut the portion of the intermediate mold 100 with respect to a depth where the micro drill is transferred.

A transfer speed of the micro drill may be preferably maintained while forming the spray opening 111 by the micro drill. The transfer speed may be generally controlled by a general control unit.

Sintering of the intermediate mold 100 is performed in a high-temperature sintering furnace 320 to remove a pore of the intermediate mold 100, and thus manufacturing of the injection molding substance is complete.

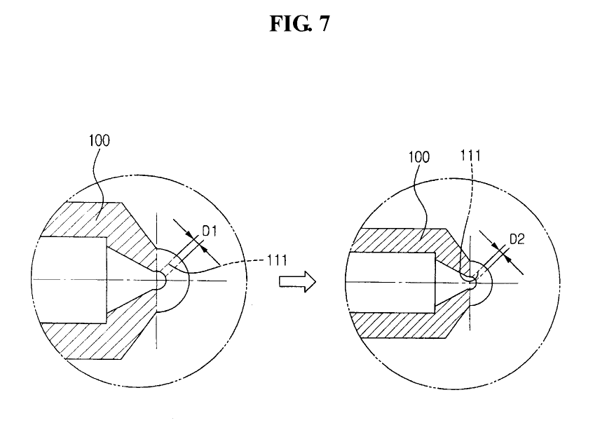

FIG. 7 is a cross-sectional view illustrating a change of a diameter of a spray opening after sintering.

As illustrated in FIG. 7, by sintering an intermediate mold 100, a pore of the intermediate mold 100 is removed, and the intermediate mold 100 as well as a diameter D1 of a spray opening 111 of the intermediate mold 100 is reduced. Accordingly, the spray opening 111 having a micromini diameter D2 may be formed.

That is, through the method described above, the spray opening 111 having the micromini diameter D2, which is much smaller than the diameter D1 of the spray opening 111 by a mechanical method, may be formed. Also, sintering shrinkage ratios of an X axis, a Y axis, and a Z axis may be identical since a density of the intermediate mold 100 by an injection molding is almost uniform. Accordingly, a relatively high rate of precision of the spray opening 111 may be maintained.

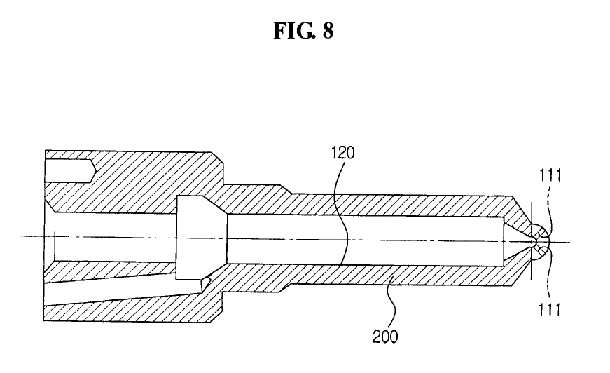

FIG. 8 is a cross-sectional view illustrating a configuration of an injection molding substance according to an embodiment of the present invention.

FIG. 8 illustrates a product 200 manufactured by a method of manufacturing an injection molding substance described above. The product 200 may be used as a nozzle body of an injection nozzle for a diesel engine.

A fuel provided from an injection pump is transferred to pressure chamber 120.

Also, a post machining may be added after sintering to improve precision and a quality of the product 200.

The nozzle body of the injection nozzle for the diesel engine is manufactured by a MIM, and forming of a spray opening 111 is performed before sintering an intermediate mold 100. Accordingly, the injection molding substance may be easily manufactured and a manufacturing cost may decrease.

Specifically, according to the present invention, the forming of the spray opening 111 is performed in the intermediate mold 100 which is relatively weaker than a wear resistant base metal. Thus, the injection molding substance may be easily manufactured, and the manufacturing cost may decrease compared to directly cutting the wear resistant base metal.

Also, according to the present invention, a binder having a relatively low melting point, e.g. a wax, is removed before cutting a portion of the intermediate mold 100. Accordingly, an increase in the chip exhaustion load and the cutting rotation load, caused by the wax melted by heat generated by the cutting, may be previously prevented.

Also, according to the present invention, since the intermediate mold 100 may be in a nozzle shape when making the intermediate mold 100, a separate internal/external machining to form a wear resistant base metal in the nozzle shape may be omitted. Also, wasted process scrap may decrease.

Also, according to the present invention, the intermediate mold 100 is sintered and contracted, and a diameter of the spray opening 111 is reduced. Accordingly, the spray opening 111 having a micromini diameter may be formed.

Although an example of manufacturing the injection nozzle for the diesel engine according to the method of manufacturing an injection molding substance is described in the present embodiment of the present invention, the present invention may be applied to manufacturing a mechanical component used in a car, consumer electronics, a precision instrument, and the like.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

### INDUSTRIAL APPLICABILITY

According to the present invention, in a method of manufacturing an injection molding substance, the injection molding substance is manufactured by a MIM, cutting a portion of an intermediate mold is performed according to a request before sintering the intermediate mold, and thus the injection molding substance may be easily manufactured and a manufacturing cost may decrease.

Also, according to the present invention, a binder having a relatively low melting point, e.g. a wax, is removed before cutting a portion of an intermediate mold, and thus an increase in the chip exhaustion load and the cutting rotation load, caused by the wax melted by heat generated by the cutting, may be previously prevented.

Also, according to the present invention, an intermediate mold may be formed in various shapes depending on a need when making the intermediate mold, and thus a separate cutting process may be omitted, and wasted process scrap may decrease.

Also, according to the present invention, a manufacturing process of an injection nozzle for a diesel engine may be simplified, and thus the injection nozzle for the diesel engine may be mass produced, a manufacturing cost may be reduced, and a unit price may decrease.

Also, according to the present invention, a high rate of precision may be maintained and a spray opening having a micromini diameter may be formed.

1. A method of manufacturing an injection molding substance, the method comprising:
providing a molding compound including a powder;
making an intermediate mold by injection molding using the molding compound;
cutting a portion of the intermediate mold; and
sintering the cut intermediate mold.

2. The method of claim 1, wherein:
the molding compound further comprises a binder, and
the method further comprises degreasing the intermediate mold to enable at least a portion of the binder to be removed before the cutting the portion of the intermediate mold.

3. The method of claim 1, wherein:
the molding compound further comprises a binder, and
the method further comprises degreasing the cut intermediate mold to enable at least a portion of the binder to be removed before the sintering the intermediate mold.

4. The method of claim 1, wherein the intermediate mold is formed to have a porosity from 10% to 90%.

5. The method of claim 1, wherein the powder comprises any one selected from a group consisting of a metal powder, and a nonmetal powder.

6. The method of claim 1, wherein the intermediate mold is formed in a nozzle shape in the making the intermediate mold, and a spray opening is formed in the intermediate mold in the cutting the portion of the intermediate mold.

7. The method of claim 6, wherein a plurality of the spray openings is formed simultaneously or sequentially in the cutting the portion of the intermediate mold.

8. The method of claim 6, wherein a proportion of a depth to a diameter of the spray opening is from 1 to 100.

9. The method of claim 6, wherein the spray opening is formed by a micro drill.

10. The method of claim 9, wherein a diameter of the micro drill is any one of 0.05 mm, 0.1 mm, 0.15 mm, 0.2 mm, 0.25 mm, and 0.3 mm.

11. The method of claim 9, wherein the spray opening is formed by repeatedly reciprocating the micro drill.

12. The method of claim 9, wherein a transfer speed of the micro drill is constantly maintained while the spray opening is formed.

13. A method of manufacturing an injection molding substance, the method comprising:
providing a molding compound including a powder and a plurality of binders, the plurality of binders having a melting point different from each other;
making an intermediate mold by injection molding using the molding compound;
degreasing the intermediate mold to enable a binder having a relatively low melting point to be removed from the intermediate mold;
cutting a portion of the degreased intermediate mold; and
sintering the cut intermediate mold.

14. The method of claim 13, wherein the plurality of binders comprises a wax and a plastic.

15. The method of claim 14, wherein the wax is removed in the degreasing the intermediate mold.

16. The method of claim 13, wherein the binder having the relatively low melting point is removed by a solvent degreasing method using a solvent in the degreasing the intermediate mold.

17. The method of claim 13, further comprising:
degreasing the cut intermediate mold to enable a binder having a relatively high melting point to be removed from the intermediate mold.

18. The method of claim 17, wherein the plurality of binders comprises a wax and a plastic, and the plastic is removed in the degreasing the cut intermediate mold.

19. The method of claim 17, wherein the binder having the relatively high melting point is removed from the intermediate mold by a pyrolysis degreasing method in the degreasing the cut intermediate mold.

20. The method of claim 13, wherein the intermediate mold is formed to have a porosity from 10% to 90%.

21. The method of claim 13, wherein the powder comprises any one selected from a group consisting of a metal powder, and a nonmetal powder.

22. The method of claim 13, wherein the intermediate mold is formed in a nozzle shape in the making the intermediate mold, and a spray opening is formed in the intermediate mold in the cutting the portion of the degreased intermediate mold.

23. The method of claim 22, wherein the plurality of spray openings is formed simultaneously or sequentially in the cutting the portion of the degreased intermediate mold.

24. The method of claim 22, wherein a proportion of a depth to a diameter of the spray opening is from 1 to 100.

25. The method of claim 22, wherein the spray opening is formed by a micro drill.

26. The method of claim 25, wherein a diameter of the micro drill is any one of 0.05 mm, 0.1 mm, 0.15 mm, 0.2 mm, 0.25 mm, and 0.3 mm.

27. The method of claim 25, wherein the spray opening is formed by repeatedly reciprocating the micro drill.

28. The method of claim 25, wherein a transfer speed of the micro drill is constantly maintained while the spray opening is formed.

29. An injection molding substance which is manufactured by the method of any one of claims 1 through 28.
